(19) United States
(12) Patent Application Publication
(10) Pub. No.: US 2025/0301069 A1
(43) Pub. Date: Sep. 25, 2025

(54) IMAGE DIAGNOSIS SYSTEM

(71) Applicant: FUJIFILM Business Innovation Corp., Tokyo (JP)

(72) Inventors: Naoto SAITO, Kanagawa (JP); Shinya MIYAMORI, Kanagawa (JP); Tomoya OKI, Kanagawa (JP)

(73) Assignee: FUJIFILM Business Innovation Corp., Tokyo (JP)

(21) Appl. No.: 18/820,238

(22) Filed: Aug. 29, 2024

(30) Foreign Application Priority Data
Mar. 25, 2024 (JP) 2024-048177

(51) Int. Cl. H04N 1/00; G06T 7/00

(52) U.S. Cl. CPC H04N 1/00029; G06T 7/001; H04N 1/00045; H04N 1/00092; G06T 2207/10008; G06T 2207/30144

(57) ABSTRACT

An image diagnosis system is configured to: scan paper before an image for image diagnosis is formed by an image forming apparatus; scan the paper after the image is formed by the image forming apparatus; and perform the image diagnosis by classifying at least one of a fault due to the paper, a fault due to the scanning, or a fault due to the image formation from the other fault, based on a scan image of the paper before the image is formed and a scan image of the paper after the image is formed.

### CROSS-REFERENCE TO RELATED APPLICATIONS

This application is based on and claims priority under 35 USC 119 from Japanese Patent Application No. 2024-048177 filed Mar. 25, 2024.

### BACKGROUND

### (i) Technical Field

The present invention relates to an image diagnosis system.

### (ii) Related Art

JP2007-116670A provides a failure diagnosis system capable of accurately specifying a failure location, as an object. For this object, a technique is disclosed in which a fault image pattern is subjected to pattern matching with document data to detect whether or not the fault image pattern exists in the manuscript data.

JP2015-103909A has an object of correctly specifying an “abnormal image” of a printer in a case of acquiring a scan image. For this object, an apparatus disclosed in JP2015-103909A acquires first image data obtained by scanning blank paper by scanning, and second image data obtained by scanning a chart formed by an image forming section by scanning. A technique is disclosed in which the second image data is changed by using the first image data, and a cause of an abnormality occurring by the image forming section is estimated from a feature amount obtained by analyzing the changed image data.

### SUMMARY

For example, in a case where an image forming apparatus of a customer is in a trouble state, an image diagnosis system that detects an abnormality of the image forming apparatus is used by a customer engineer of the image forming apparatus to promptly handle this trouble.

Here, as the image diagnosis system, there is a technique of detecting features of points or lines existing in an image and specifying an image fault occurring in image formation or image scanning. Meanwhile, in a case where the image fault is specified by image scanning, in a case where a noise (for example, a foreign matter or dust) is included on paper for scanning an image, the noise on the paper may be erroneously detected as the image fault occurring by the image formation or the image scanning.

Aspects of non-limiting embodiments of the present disclosure relate to an image diagnosis system that prevents erroneous detection of a noise on paper as an image fault.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image diagnosis system configured to: scan paper before an image for image diagnosis is formed by an image forming apparatus; scan the paper after the image is formed by the image forming apparatus; and perform the image diagnosis by classifying at least one of a fault due to the paper, a fault due to the scanning, or a fault due to the image formation from the other fault, based on a scan image of the paper before the image is formed and a scan image of the paper after the image is formed.

### BRIEF DESCRIPTION OF THE DRAWINGS

Exemplary embodiment(s) of the present invention will be described in detail based on the following figures, wherein:

FIG. 1 is a diagram illustrating an example of an image diagnosis system to which the present exemplary embodiment is applied;

FIG. 2 is a diagram illustrating a hardware configuration example of a server apparatus and an information processing unit provided in an image forming apparatus;

FIG. 3 is a diagram describing the image forming apparatus;

FIG. 4 is a diagram describing a first diagnosis example of the image diagnosis system to which the present exemplary embodiment is applied;

FIG. 5 is a diagram describing a second diagnosis example of the image diagnosis system to which the present exemplary embodiment is applied;

FIG. 6 is a diagram describing a third diagnosis example of the image diagnosis system to which the present exemplary embodiment is applied;

FIGS. 7A to 7C are charts describing a classification described in the third diagnosis example;

FIG. 8 is a diagram describing a fourth diagnosis example of the image diagnosis system to which the present exemplary embodiment is applied;

FIG. 9 is a diagram describing a fifth diagnosis example of the image diagnosis system to which the present exemplary embodiment is applied;

FIG. 10 is a flowchart describing a flow of image diagnosis in the server apparatus;

FIG. 11 is a flowchart illustrating an example of a process of switching by a mode; and

FIG. 12 is a flowchart illustrating another example of the process of switching by the mode.

### DETAILED DESCRIPTION

Hereinafter, an exemplary embodiment of the present disclosure will be described with reference to the accompanying drawings.

### Image Diagnosis System 1

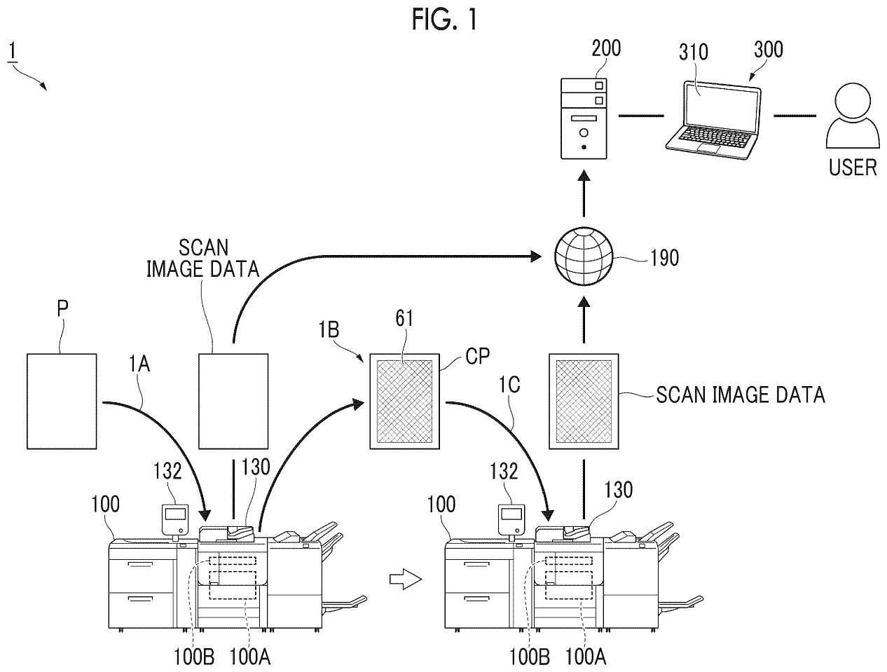

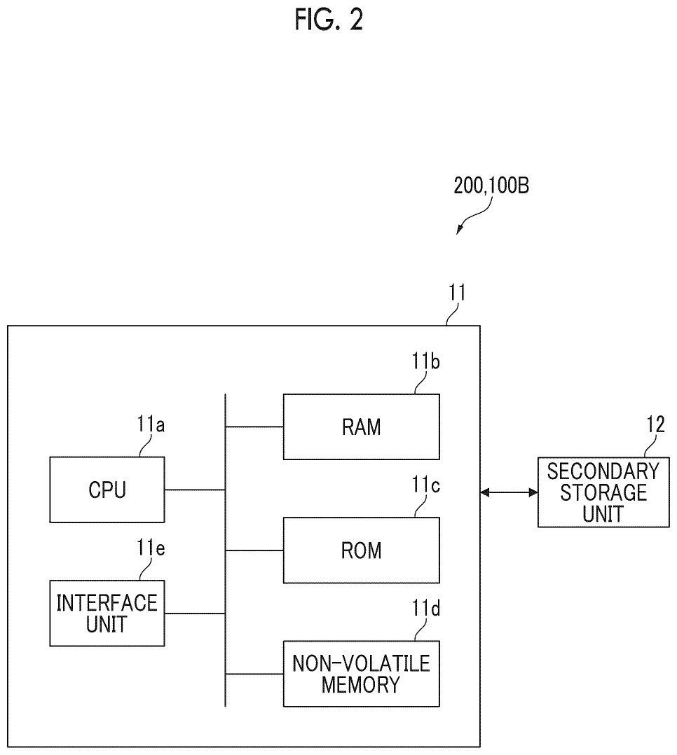

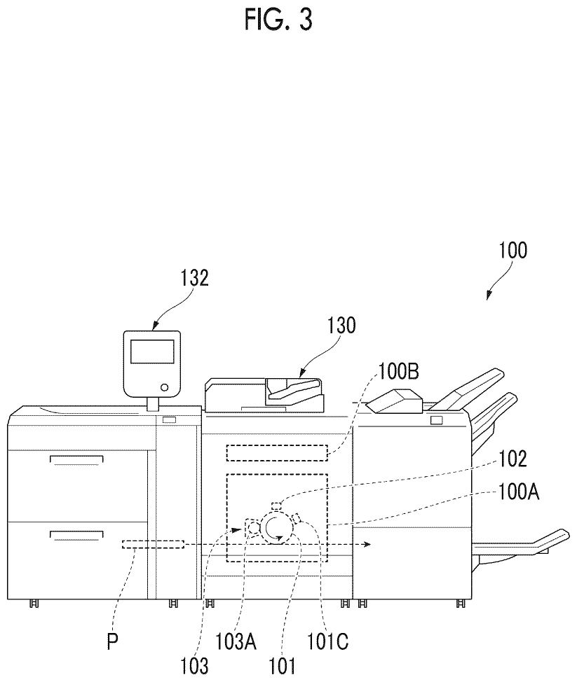

FIG. 1 is a diagram illustrating an example of an image diagnosis system 1 to which the present exemplary embodiment is applied. In addition, FIG. 2 is a diagram illustrating a hardware configuration example of a server apparatus 200 and an information processing unit 100B provided in an image forming apparatus 100. In addition, FIG. 3 is a diagram describing the image forming apparatus 100.

The image diagnosis system 1 according to the present exemplary embodiment is provided with a plurality of image forming apparatuses 100 and a server apparatus 200 that is connected to each of the plurality of image forming apparatuses 100 via a communication line 190. The server apparatus 200 is an example of an image diagnosis unit, and in the present exemplary embodiment, image diagnosis of the image diagnosis system 1 is performed by the server apparatus 200. Further, the image diagnosis system 1 is provided with a user terminal 300 that is connected to the server apparatus 200, and receives an operation from a user.

In FIG. 1, two image forming apparatuses 100 among the plurality of image forming apparatuses 100 are displayed.

The user terminal 300 is provided with a display device 310. The user terminal 300 is realized by a computer. Examples of a form of the user terminal 300 include a personal computer (PC), a smartphone, and a tablet terminal.

An image forming unit 100A that forms an image on paper is provided in the image forming apparatus 100.

The image forming apparatus 100 is further provided with the information processing unit 100B. The information processing unit 100B executes various processes executed in the image forming apparatus 100.

The server apparatus 200 and the information processing unit 100B provided in the image forming apparatus 100 are realized by a computer.

As illustrated in FIG. 2, each of the server apparatus 200 and the information processing unit 100B includes an arithmetic processing unit 11 that executes a digital arithmetic process according to a program, and a secondary storage unit 12 that stores information.

The secondary storage unit 12 is realized, for example, by a known information storage device such as a hard disk drive (HDD), a semiconductor memory, or a magnetic tape.

The arithmetic processing unit 11 is provided with a CPU 11a as an example of a processor.

In addition, the arithmetic processing unit 11 is provided with a RAM 11b used as a working memory or the like of the CPU 11a and a ROM 11c in which programs or the like executed by the CPU 11a are stored.

In addition, the arithmetic processing unit 11 is provided with a non-volatile memory 11d that is configured to be rewritable and can hold data even in a case where power supply is interrupted and an interface unit 11e that controls each unit, such as a communication unit, connected to the arithmetic processing unit 11.

The non-volatile memory 11d is configured with, for example, an SRAM or a flash memory that is backed up by a battery. The secondary storage unit 12 stores the programs executed by the arithmetic processing unit 11 in addition to files and the like.

In the present exemplary embodiment, the arithmetic processing unit 11 reads the program stored in the ROM 11c or the secondary storage unit 12 to execute each process.

The program executed by the CPU 11a can be provided to the server apparatus 200 and the information processing unit 100B in a state in which the program is stored in a computer-readable recording medium such as a magnetic recording medium (for example, a magnetic tape or a magnetic disk), an optical recording medium (for example, an optical disk), a magneto-optical recording medium, or a semiconductor memory. Further, the program executed by the CPU 11a may be provided to the server apparatus 200 and the information processing unit 100B by a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process executed by the image forming apparatus 100 among the processes described below is executed by the CPU 11a provided in the image forming apparatus 100. The process executed by the server apparatus 200 among the processes described below is executed by the CPU 11a as an example of the processor provided in the server apparatus 200.

In addition, in the process described below, the server apparatus 200 performs a process related to the image diagnosis of the image diagnosis system 1. The process related to the image diagnosis of the image diagnosis system 1 may be realized by one apparatus such as one server apparatus 200 or may be realized by a plurality of apparatuses.

As illustrated in FIG. 3, the image forming unit 100A that forms an image on paper P is provided in the image forming apparatus 100.

The image formation on the paper P by the image forming unit 100A is performed by using, for example, an electrophotographic method.

A photosensitive drum 101 as an image holding body is provided in the image forming unit 100A.

Further, the image forming unit 100A is provided with a charging device 101C that performs charging on the photosensitive drum 101, an exposure device 102 that performs exposure on the photosensitive drum 101, and a developing device 103 that performs development on an electrostatic latent image formed on the photosensitive drum 101 by the exposure with the exposure device 102.

The developing device 103 is provided with a developing roll 103A disposed at a position facing the photosensitive drum 101. In the present exemplary embodiment, development is performed by a developer adhering to an outer peripheral surface of the developing roll 103A moving to a surface of the photosensitive drum 101.

In a case where the development is performed, an image formed of a toner is formed on the photosensitive drum 101. Thereafter, this image is transferred to the paper P passing through the image forming unit 100A, and the toner image is fixed on the paper P by a fixing unit (not illustrated), and an image is formed on the paper P.

The image may be transferred from the photosensitive drum 101 to the paper P via an intermediate transfer body (not illustrated) such as an intermediate transfer belt.

In addition, the formation of the image on the paper P by the image forming unit 100A is not limited to the electrophotographic method, and other methods such as an ink jet method may be used.

The image forming apparatus 100 is further provided with an image scanning unit 130 that scans the image formed on the paper P.

The image scanning unit 130 is a so-called scanner having a function of transporting the paper P. The image scanning unit 130 includes a light source that emits light with which paper is to be irradiated and a light receiving unit such as a CCD that receives reflected light from the paper. In the present exemplary embodiment, scan image data described below is generated based on the reflected light received by the light receiving unit.

A scanning position of an image is set in advance in the image scanning unit 130, and the image scanning unit 130 scans an image at a portion of paper that is sequentially transported, which is located at the scanning position.

In addition, the image forming apparatus 100 has an information transmission function to transmit information to the server apparatus 200 (see FIG. 1).

In the example illustrated in FIG. 3, the image scanning unit 130 is provided at an upper portion of the image forming apparatus 100. The image scanning unit 130 sequentially scans the paper P set by the user.

An installation form of the image scanning unit 130 is not limited to the form illustrated in FIG. 3. The image scanning unit 130 may be provided inside the image forming apparatus 100 and on a transport path of paper P.

In this case, the paper P on which an image is formed by the image forming unit 100A sequentially passes through the image scanning unit 130, and at the time of passing through the paper P, each image of the paper P is scanned in order.

In the present exemplary embodiment, the image scanning unit 130 is provided with a reversing mechanism of the paper P such that the paper P can be supplied after the front and back sides are reversed with respect to the scanning position of the image.

Therefore, in the present exemplary embodiment, the paper P on which an image formed on one side is scanned can be reversed and supplied to the scanning position again. Therefore, images on the front and back sides of the paper P can be scanned.

In addition, in scanning an image on the paper P, the paper P may be placed on a document stand (not illustrated) configured with plate-shaped glass or the like such that the paper P placed on the document stand may be scanned.

Further, each image forming apparatus 100 is provided with an operation reception unit 132 that receives an operation from the user. The operation reception unit 132 is configured with a so-called touch panel. The operation reception unit 132 displays information for the user and receives an operation performed by the user.

The display of information for the user and the reception of the operation by the user are not limited to being performed by one operation reception unit 132 as in the present exemplary embodiment. The operation reception unit and the information display unit may be provided separately.

In the present exemplary embodiment, in a case where image diagnosis of the image diagnosis system 1 (see FIG. 1) is performed, first, as indicated by a reference numeral 1A in FIG. 1, the paper P is placed in the image scanning unit 130. The image scanning unit 130 is operated to scan the paper P. Therefore, scan image data of the paper P is generated.

The image forming unit 100A is operated to form a diagnosis image 61 on the paper P. Therefore, as indicated by a reference numeral 1B in FIG. 1, diagnosis paper CP which is the paper P on which the diagnosis image 61 is formed is generated.

The diagnosis image 61 is an image to be used to diagnose the image forming apparatus 100. In the present exemplary embodiment, the diagnosis paper CP which is the paper P on which the diagnosis image 61 to be used for the diagnosis is formed is generated. The diagnosis paper CP is paper after an image is formed.

In a case where the diagnosis paper CP is generated, as indicated by a reference numeral 1C in FIG. 1, the diagnosis paper CP is placed in the image scanning unit 130. The image scanning unit 130 is used to scan the diagnosis paper CP on which the diagnosis image 61 is formed. Scan image data of the diagnosis paper CP is generated.

In the present exemplary embodiment, the scan image data of the paper P and the scan image data of the diagnosis paper CP are transmitted to the server apparatus 200 and stored in the server apparatus 200. The server apparatus 200 performs image diagnosis by the image diagnosis system 1 based on the scan image data of the paper P and the scan image data of the diagnosis paper CP.

In the present exemplary embodiment, a user who uses the image diagnosis system 1 in the present exemplary embodiment, such as a maintenance person who maintains the image forming apparatus 100, accesses the server apparatus 200 and refers to a result of the diagnosis by the server apparatus 200.

In addition, in the present exemplary embodiment, as indicated by the reference numeral 1A in FIG. 1, the paper P before the diagnosis image 61 is formed is scanned by the image scanning unit 130. As a result, from the scan image on the paper P before the image is formed, and the scan image on the paper P after the image is formed, at least one of a fault due to the paper P, a fault due to the scanning, or a fault due to the image formation by the image forming unit 100A is classified from the others to perform the image diagnosis.

### First Diagnosis Example

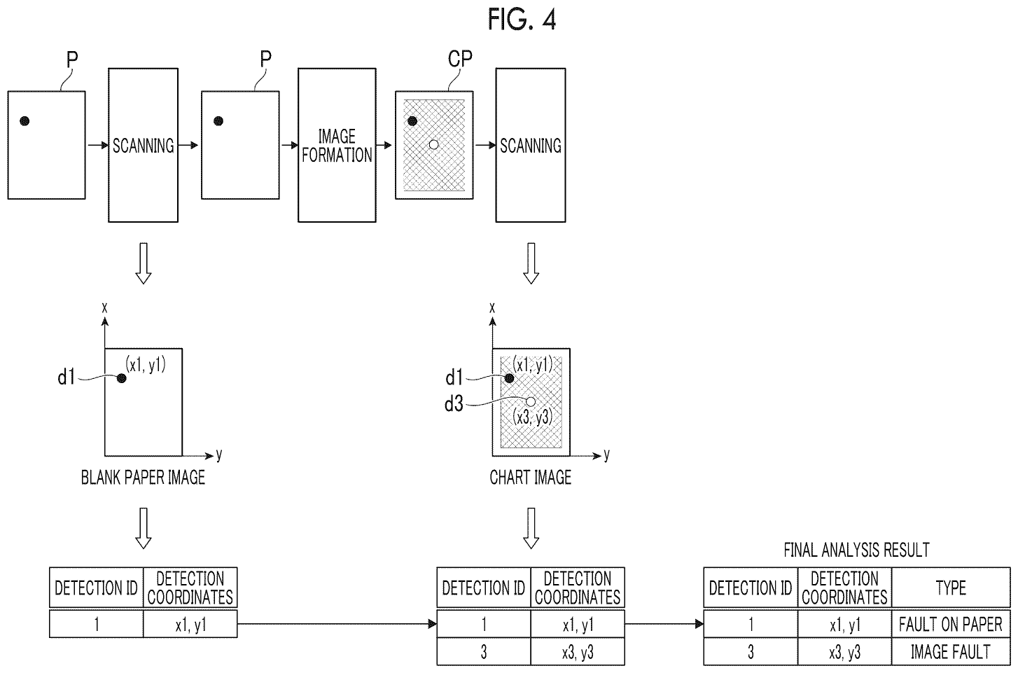

FIG. 4 is a diagram describing a first diagnosis example of the image diagnosis system 1 to which the present exemplary embodiment is applied. This first diagnosis example is an example in which a fault due to the paper P and a fault due to the image formation by the image forming unit 100A (see FIG. 1) are classified. Examples of the fault due to the paper P include a foreign matter adhering to the paper P, dirt on the paper P, an image drawn on the paper P, and the like. In addition, examples of the fault due to image formation include a line, a reticulation, a streak, and a toner stain adhering to the paper P, and the like. The fault due to the image formation by the image forming unit 100A occurs, for example, by a surface fault of the photosensitive drum 101, adhesion of the toner during the transport of the paper P, adhesion of the toner during the image fixing, and the like. The fault due to the image formation by the image forming unit 100A (see FIG. 1) may be simply referred to as faults due to the image formation.

In the example illustrated in FIG. 4, first, the image scanning unit 130 (see FIG. 1) scans the paper P before the image is formed, and the scan image data of the paper P is transmitted to the server apparatus 200 (see FIG. 1). In the present exemplary embodiment, the scan image data of the paper P before the image is formed is referred to as a “blank paper image”. Here, in the present exemplary embodiment, in scanning, a main scanning direction is represented by x, and a sub-scanning direction is represented by y. For example, in a case where a fault d1 exists on the paper P, detection coordinates (x1, y1) of the fault d1 are scanned by the image scanning unit 130. The detection coordinates (x1, y1) of the fault d1 of the scanned blank paper image are transmitted to the server apparatus 200 with information on the coordinates. Here, the detection coordinates (x1, y1) of the fault d1 are set as a detection ID1.

Next, the image forming unit 100A forms the diagnosis image 61 for image diagnosis on the paper P scanned by the image scanning unit 130 before the image is formed. This is the diagnosis paper CP. The formed image for image diagnosis is, for example, an image that is a criterion for performing quality evaluation or calibration of the image formed by the image forming unit 100A. The diagnosis paper CP is scanned by the image scanning unit 130, and scan image data of the diagnosis paper CP is transmitted to the server apparatus 200. In the present exemplary embodiment, the scan image data of the diagnosis paper CP is represented as a “chart image”. This chart image is a scan image of the paper P after the image is formed by the image forming unit 100A.

Here, for example, a case where a fault d3 (detection coordinates (x3, y3)) due to the image formation by the image forming unit 100A exists will be considered. In this case, in the chart image, the fault d1 that originally exists on the paper P and the fault d3 due to image formation are formed, in addition to the image for image diagnosis. The detection coordinates (x1, y1) of the fault dl and the detection coordinates (x3, y3) of the fault d3 are scanned by the image scanning unit 130. Regarding the scanned detection coordinates of the fault d1 (x1, y1) and the scanned detection coordinates of the fault d3 (x3, y3), information on these coordinates is transmitted to the server apparatus 200. Here, the detection coordinates (x1, y1) of the fault dl are set as the detection ID1, and the detection coordinates (x3, y3) of the fault d3 are set as a detection ID3.

In the server apparatus 200, the image diagnosis is executed by the transmitted blank paper image and the transmitted chart image. First, the server apparatus 200 can recognize the fault d1 due to the paper P by the transmitted blank paper image. The server apparatus 200 removes the detection coordinates (x1, y1) of the fault dl due to the paper P recognized by the blank paper image from a list of coordinates of the transmitted chart image. The fault d3 that does not exist in the original image for image diagnosis is specified. In this first diagnosis example, the image diagnosis is performed in a state in which a type of fault due to the paper P and a type of fault due to the image formation by the image forming unit 100A are classified. In FIG. 4, the fault due to the paper P is simply referred to as a paper fault, and the fault due to the image formation is simply referred to as an image fault, and the same may be applied to the following drawings.

### Second Diagnosis Example

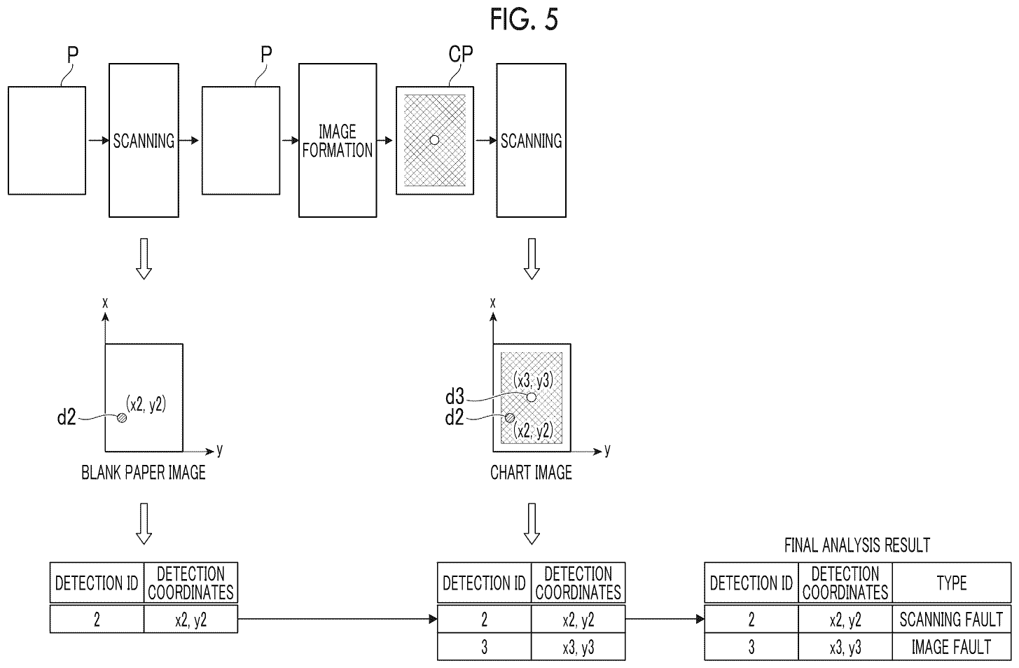

FIG. 5 is a diagram describing a second diagnosis example of the image diagnosis system 1 to which the present exemplary embodiment is applied. This second diagnosis example is an example in which a fault due to scanning of an image by the image scanning unit 130 (see FIG. 1) and a fault due to image formation by the image forming unit 100A (see FIG. 1) are classified. For example, the fault due to scanning includes, for example, dirt on a scanning surface of a document stand or a sensor, a fault of the sensor itself, and the like. These faults appear as a missing part, unevenness, or the like of the scan image. The fault due to scanning the image by the image scanning unit 130 may be simply referred to as a fault due to scanning.

In the example illustrated in FIG. 5, first, the paper P before the image is formed is scanned by the image scanning unit 130, and a blank paper image, which is scan image data of the paper P, is transmitted to the server apparatus 200 (see FIG. 1). Here, for example, in a case where a fault d2 due to the scanning exists, detection coordinates (x2, y2) of the fault d2 appear in the blank paper image. Regarding the detection coordinates (x2, y2) of the fault d2, information on the coordinates is transmitted to the server apparatus 200. Here, the detection coordinates (x2, y2) of this fault d2 are set as a detection ID2.

Next, the image forming unit 100A forms the diagnosis image 61 for image diagnosis on the paper P scanned by the image scanning unit 130 before the image is formed. This is the diagnosis paper CP. The diagnosis paper CP is scanned by the image scanning unit 130, and a chart image, which is scan image data of the diagnosis paper CP, is transmitted to the server apparatus 200. Here, for example, a case where the fault d3 (detection coordinates (x3, y3)) due to the image formation by the image forming unit 100A exists will be considered. In this case, the chart image includes the fault d2 due to scanning and the fault d3 due to image formation, in addition to the image for image diagnosis. Regarding the detection coordinates (x2, y2) of the fault d2 and the detection coordinates (x3, y3) of the fault d3, information on the detection coordinates are transmitted to the server apparatus 200. Here, the detection coordinates (x2, y2) of the fault d2 are set as the detection ID2, and the detection coordinates (x3, y3) of the fault d3 are set as the detection ID3.

In the server apparatus 200, the image diagnosis is executed by the transmitted blank paper image and the transmitted chart image. First, the server apparatus 200 can recognize the fault d2 due to the scanning, from the transmitted blank paper image. The server apparatus 200 removes the detection coordinates (x2, y2) of the fault d2 due to the scanning recognized by the blank paper image from a list of coordinates of the transmitted chart image. Then, the fault d2 due to the scanning is specified. In this second diagnosis example, the image diagnosis is performed in a state in which a type of fault d2 due to the scanning of the image by the image scanning unit 130 and a type of fault d3 due to the image formation by the image forming unit 100A are classified. In FIG. 5, the fault due to the scanning is simply referred to as a scanning fault, and the fault due to the image formation is simply referred to as an image fault, and the same may be applied to the following drawings.

### Third Diagnosis Example

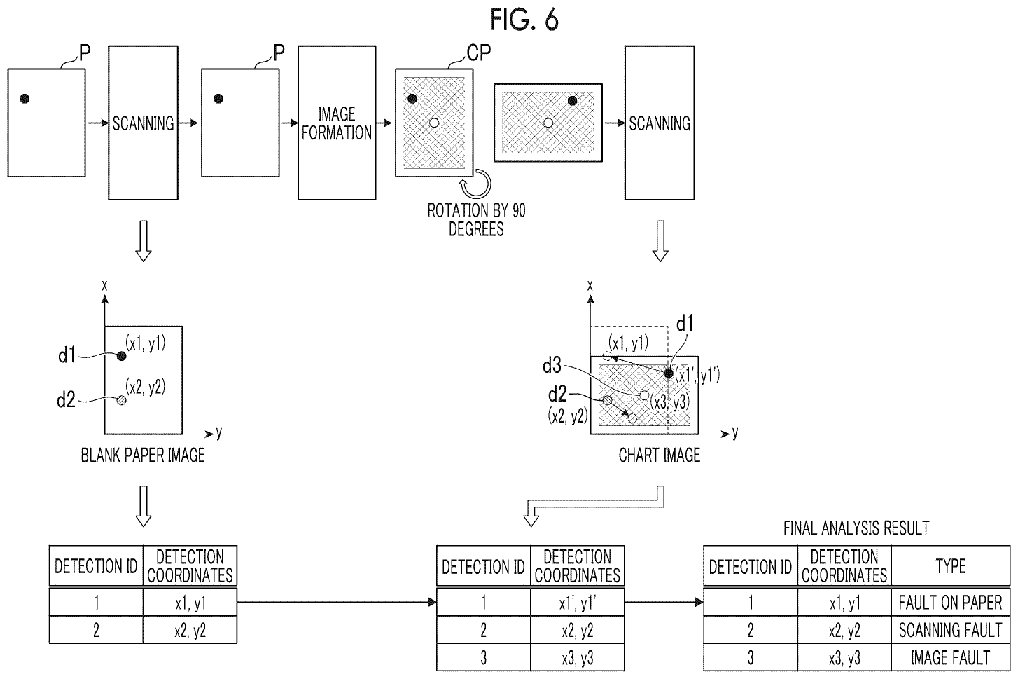

FIG. 6 is a diagram describing a third diagnosis example of the image diagnosis system 1 to which the present exemplary embodiment is applied. This third diagnosis example is an example in which a fault due to the paper P, a fault due to scanning, and a fault due to image formation are classified by rotating the paper P and changing a scanning direction of the paper P to scan the paper P.

In the example illustrated in FIG. 6, first, the paper P before an image is formed is scanned by the image scanning unit 130 (see FIG. 1), and a blank paper image, which is scan image data of the paper P, is transmitted to the server apparatus 200 (see FIG. 1). Here, for example, in a case where the fault d1 due to the paper P and the fault d2 due to scanning exist, the fault d1 and the fault d2 appear in the blank paper image. Regarding the detection coordinates (x1, y1) of the fault d1 and the detection coordinates (x2, y2) of the fault d2, information on the coordinates is transmitted to the server apparatus 200. Here, the detection coordinates (x1, y1) of the fault d1 are set as the detection ID1. Further, the detection coordinates (x2, y2) of the fault d2 are set as the detection ID2.

Next, the image forming unit 100A (see FIG. 1) forms the diagnosis image 61 for image diagnosis on the paper P scanned by the image scanning unit 130 before the image is formed. This is the diagnosis paper CP. A scanning direction of the diagnosis paper CP is changed from the scanning direction of the paper P, and the diagnosis paper CP is scanned. In the example illustrated in FIG. 6, the diagnosis paper CP is scanned by the image scanning unit 130 in a state in which the scanning direction of the diagnosis paper CP is rotated by 90 degrees from the scanning direction of the paper P. A chart image, which is scan image data of the diagnosis paper CP, is transmitted to the server apparatus 200. Here, for example, a case where the fault d3 (detection coordinates (x3, y3)) due to the image formation by the image forming unit 100A exists will be considered. In this case, in the chart image, in addition to the image for image diagnosis, the fault d1 originally existing on the paper P, the fault d2 due to the scanning, and the fault d3 due to image formation are formed. Here, the fault d1 is located at detection coordinates (x1′, y1′) different from the detection coordinates (x1, y1) in the blank paper image by rotating the scanning direction of the diagnosis paper CP by 90 degrees from the scanning direction of the paper P. The server apparatus 200 can recognize that the scanning direction is rotated by 90 degrees by size information on the blank paper image and the chart image. For example, in a case where the blank paper image has an image size of vertical A4 and the chart image has an image size of horizontal A4, it can be recognized that the image is rotated by 90 degrees in accordance with a difference in the sizes of the images (a difference between vertical and horizontal).

As a chart image in which the detection coordinates (x1′, y1′) of the fault d1 and the detection coordinates (x3, y3) of the fault d3 are scanned by the image scanning unit 130 and to which the detection coordinates (x2, y2) of the fault d2 due to the scanning is added, information on the coordinates thereof is transmitted to the server apparatus 200. Here, the detection coordinates (x1′, y1′) of the fault d1 are referred to as the detection ID1, the detection coordinates (x2, y2) of the fault d2 are referred to as the detection ID2, and the detection coordinates (x3, y3) of the fault d3 are referred to as the detection ID3.

In the server apparatus 200, the image diagnosis is executed by the transmitted blank paper image and the transmitted chart image. First, the server apparatus 200 can recognize the fault d1 due to the paper P and the fault d2 due to scanning from the transmitted blank paper image and the transmitted chart image. More specifically, a fault that exists at the same position in both the blank paper image and the chart image even in a case where the paper P is rotated by 90 degrees can be determined as the fault d2 due to the scanning. This fault d2 is distinguished from a fault due to the image formation by the image forming unit 100A. Here, the fault d2 has the detection coordinates (x2, y2). In addition, a coordinate position of the fault detection coordinates (x1, y1) due to the paper P recognized by the blank paper image is converted into a position (x1′, y1′) in a case where the coordinates are rotated by 90 degrees. A fault at the detection coordinates (x1′, y1′) of the chart image, which are at the same position as the converted (x1′, y1′), is determined as the fault d1 due to the paper P, and is distinguished from the fault due to the image formation by the image forming unit 100A. The faults d1 and d2 determined as described above are distinguished from each other, and the fault d3 existing in addition to the faults d1 and d2 is determined to be a fault due to the image formation by the image forming unit 100A.

In this third diagnosis example, the image diagnosis is performed in a state in which the type of fault due to the scanning by the image scanning unit 130, the type of fault due to the image formation by the image forming unit 100A, and the type of fault due to the paper P are classified.

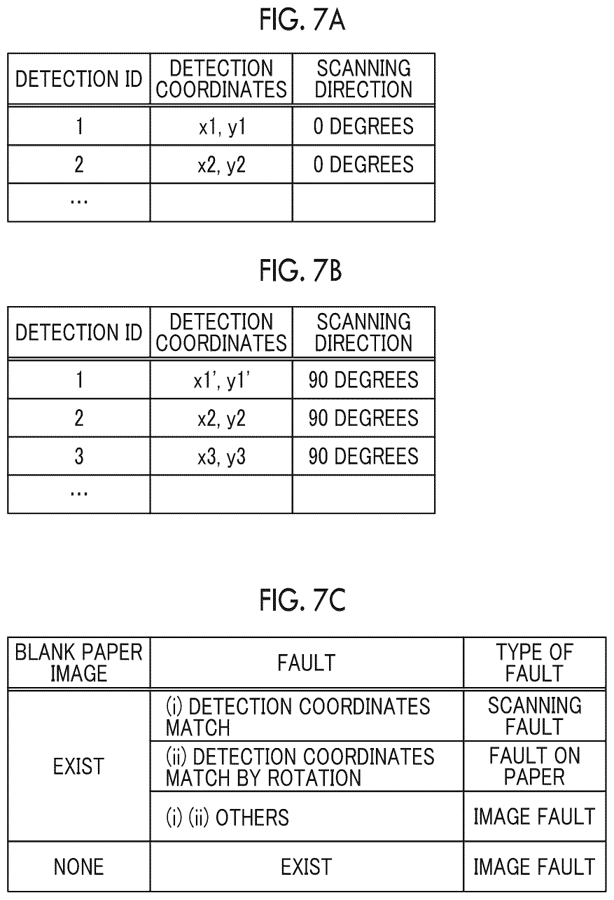

FIGS. 7A to 7C are charts describing a classification described in the third diagnosis example. FIG. 7A is a chart describing information on a fault existing in a blank paper image. FIG. 7B is a chart describing information on a fault existing in a chart image. Further, FIG. 7C is a chart describing a determination criterion in a case of classifying each fault by using the chart image.

In the example illustrated in FIG. 7A, the detection ID1 corresponding to the fault d1 and the detection ID2 corresponding to the fault d2 exist in the blank paper image. The detection ID1 has the detection coordinates (x1, y1), and the detection ID2 has the detection coordinates (x2, y2). The blank paper image obtained here has a scanning direction of 0 degrees.

In the example illustrated in FIG. 7B, the detection ID1 corresponding to the fault d1, the detection ID2 corresponding to the fault d2, and the detection ID3 corresponding to the fault d3 exist in the chart image. A scanning direction of the chart image obtained here is rotated by 90 degrees with respect to the scanning direction of the blank paper image. The detection ID1 has the detection coordinates (x1′, y1′), and the detection ID2 has the detection coordinates (x2, y2). The detection ID3 has the detection coordinates (x3, y3). Here, the detection coordinates of the detection ID1 are represented by (x1′, y1′) instead of (x1, y1). This is because the scanning direction of the chart image is different from the scanning direction of the blank paper image, and the detection coordinates of the detection ID1 corresponding to the fault d1 are different between the blank paper image and the chart image.

In the example illustrated in FIG. 7C, in this third diagnosis example, in a case where each fault is classified by using the chart image, it is first determined whether or not a fault exists in the blank paper image. In a case where a fault “exist” s in the blank paper image, a type of fault is determined by using the detection coordinates of the fault in the chart image. In a case where a fault in the blank paper image is “none”, it is determined that all the faults in the chart image are faults due to image formation by the image forming unit 100A.

In a case where a fault “exist” s in the blank paper image, (i) in a case where the detection coordinates of the fault in the blank paper image and in the chart image are the same, it can be determined that the fault is a fault due to scanning. (ii) In a case where the detection coordinates of the fault in the blank paper image and in the chart image match each other by being converted to correspond to rotation of 90 degrees, it can be determined that the fault is a fault that originally exists on the paper P. In a case where a fault “exist” s in the blank paper image, it can be determined that the fault other than (i) and (ii) is a fault due to image formation. The fault other than (i) and (ii) is a fault except for the fault of which the detection coordinates are the same and also the same after the detection coordinates are converted, in the blank paper image and the chart image.

### Fourth Diagnosis Example

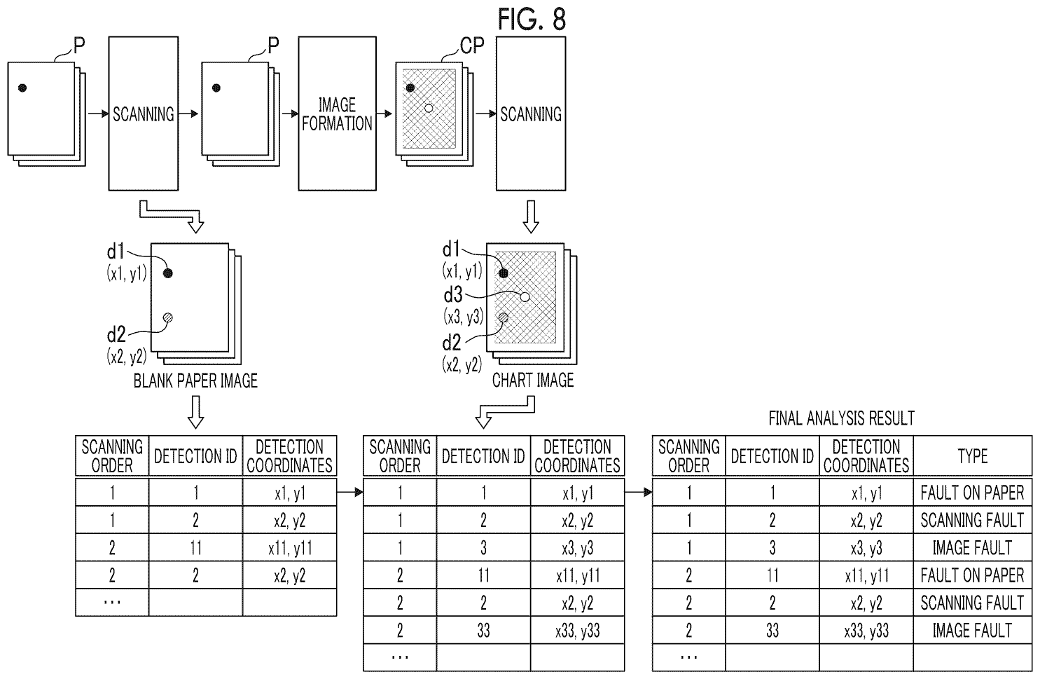

FIG. 8 is a diagram describing a fourth diagnosis example of the image diagnosis system 1 to which the present exemplary embodiment is applied. This fourth diagnosis example is an example in which a fault due to the paper P, a fault due to scanning, and a fault due to image formation are classified by scanning a plurality of sheets of paper P.

In the example illustrated in FIG. 8, the plurality of sheets of paper P before an image is formed are sequentially scanned by the image scanning unit 130 (see FIG. 1), and a plurality of blank paper images, which are scan image data of the plurality of sheets of paper P, are transmitted to the server apparatus 200 (see FIG. 1). Here, in a case where the fault d2 due to the scanning by the image scanning unit 130 exists, the fault d2 having the same detection coordinates (x2, y2) exists in all of the plurality of blank paper image. A detection ID of the fault d2 is 2. On the other hand, in a case where different faults occur in each of the blank paper images, it can be said that these different faults are faults existing in each paper P before the image is formed. In the example illustrated in FIG. 8, the detection coordinates (x1, y1) of the fault dl due to the paper P exist in the paper P having a first scanning order, and detection coordinates (x11, y11) of a fault d11 due to the paper P exist in the paper P having a second scanning order. A detection ID of the fault d1 is 1, and a detection ID of the fault d11 is 11.

In this manner, the plurality of sheets of paper P before the image is formed are sequentially scanned, and a blank paper image of each of the plurality of sheets of paper P is acquired, so that it is possible to distinguish whether a fault is a fault existing in each paper P before the image is formed or a fault due to the scanning by the image scanning unit 130.

Next, a plurality of sheets of diagnosis paper CP on which the diagnosis image 61 for image diagnosis is formed by the image forming unit 100A are generated for the plurality of sheets of paper P scanned by the image scanning unit 130 (see FIG. 1) before the image is formed. In this case, in the example illustrated in FIG. 8, an order of generating the diagnosis paper CP by the image forming unit 100A matches an order of scanning the blank paper image.

The plurality of sheets of diagnosis paper CP are scanned by the image scanning unit 130, a plurality of chart images are formed, and the plurality of chart images are transmitted to the server apparatus 200. In this case, the scanning order of the plurality of sheets of diagnosis paper CP matches the order of generating the sheets of diagnosis paper CP by the image forming unit 100A. By matching the scanning orders, a state in which an order of the plurality of sheets of paper P before the diagnosis image 61 is formed and an order of the plurality of sheets of paper P after the diagnosis image 61 is formed can be recognized.

The server apparatus 200 acquires the plurality of blank paper images and the plurality of chart images in a state in which the orders thereof match each other. Here, in a case where the fault d3 due to image formation by the image forming unit 100A exists, faults d3, d33, and . . . , which are detection coordinates (x3, y3), (x33, y33), and . . . , exist in each of the plurality of chart images. IDs of the faults d3, d33, and . . . are 3, 33, and . . . respectively. In this manner, the fault d1 and the fault d2 are distinguished from each other, and the faults d3, d33, and . . . existing in addition to the fault d1 and the fault d2 are determined to be faults due to the image formation by the image forming unit 100A. The faults d3, d33, and . . . due to the image formation do not necessarily match the coordinates between the plurality of sheets of paper P, for example, since periods of the photosensitive drum 101 and lengths of the sheets of paper P do not necessarily match.

### Fifth Diagnosis Example

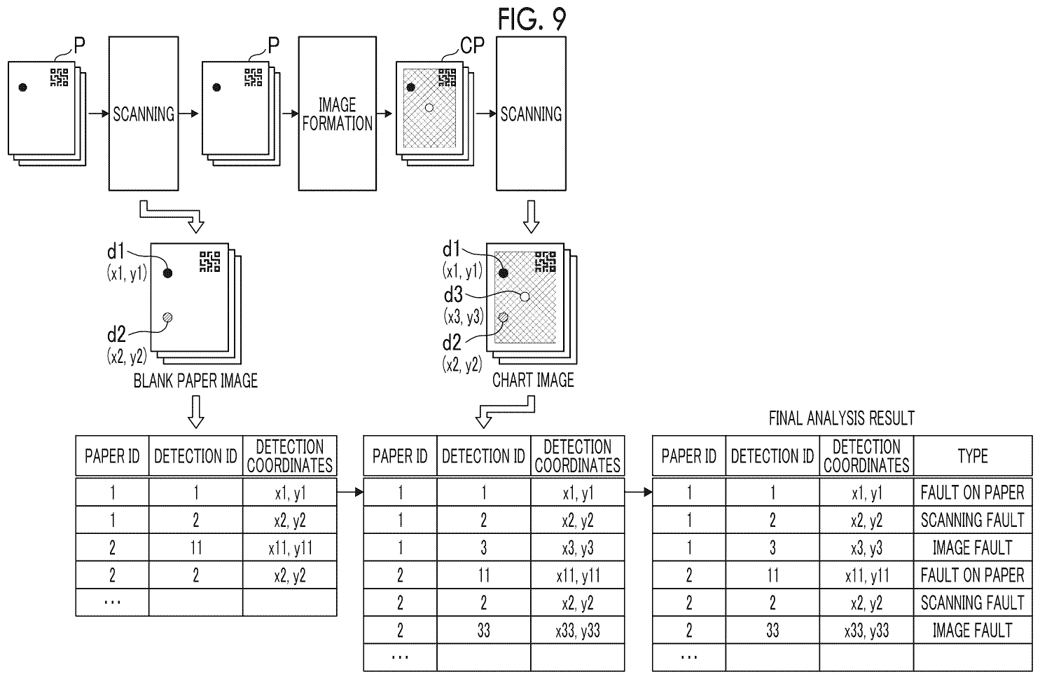

FIG. 9 is a diagram describing a fifth diagnosis example of the image diagnosis system 1 to which the present exemplary embodiment is applied. This fifth diagnosis example is an example in which identification information is added to each of the plurality of sheets of paper P, in addition to the configuration of the fourth diagnosis example.

In the example illustrated in FIG. 9, identification information is added to each paper P before image formation. The identification information is identification information for distinguishing one paper P from other paper P. In the server apparatus 200 (see FIG. 1), a paper ID is allocated based on the transmitted blank paper image and the identification information added to the chart image. Therefore, for example, even in a case where the scanning order of the paper P and the scanning order of the diagnosis paper CP are changed, the blank paper image and the chart image can be identified and diagnosed based on the identification information. For image diagnosis, the diagnosis in the same manner as the fourth diagnosis example is performed.

In FIG. 9, the paper ID of the first paper P is set to 1, and the paper ID of the second paper P is set to 2.

The identification information may be used not only in the fifth diagnosis example but also in each diagnosis example described in the present exemplary embodiment. In addition, the scanning direction of the paper P may be recognized based on the identification information. For example, in the third diagnosis example, the scanning direction of the paper P may be recognized based on the position of the identification information by adding the identification information to the paper P.

### Flow of Process by Server Apparatus 200

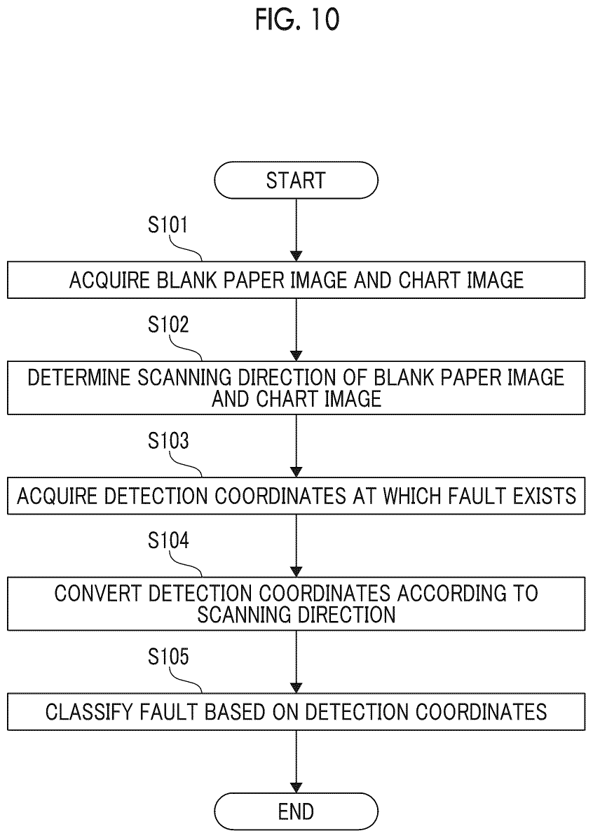

FIG. 10 is a flowchart describing a flow of image diagnosis in the server apparatus 200 (see FIG. 1). A process here is executed by the CPU 11a (see FIG. 2) provided in the server apparatus 200 as an example of a processor. First, the server apparatus 200 acquires a blank paper image that is an example of a first scan image and a chart image that is an example of a second scan image, from the image forming apparatus 100 (see FIG. 1) via the communication line 190 (see FIG. 1) (step S101). The server apparatus 200 determines scanning directions of the blank paper image and the chart image (step S102). For example, it is determined whether the scanning directions are identical directions or are directions rotated by 90 degrees. Next, the server apparatus 200 acquires detection coordinates of each fault existing in the blank paper image and the chart image (step S103). Next, the server apparatus 200 converts the detection coordinates of the fault in the blank paper image or the detection coordinates of the fault in the chart image, based on the scanning directions of the blank paper image and the chart image (step S104). The server apparatus 200 performs image diagnosis based on the detection coordinates of the fault in the blank paper image, the detection coordinates of the fault in the chart image, and the converted detection coordinates, and classifies and determines each fault existing in the blank paper image and the chart image (step S105). Therefore, for example, a fault due to the paper P, a fault due to scanning, and a fault due to image formation are classified.

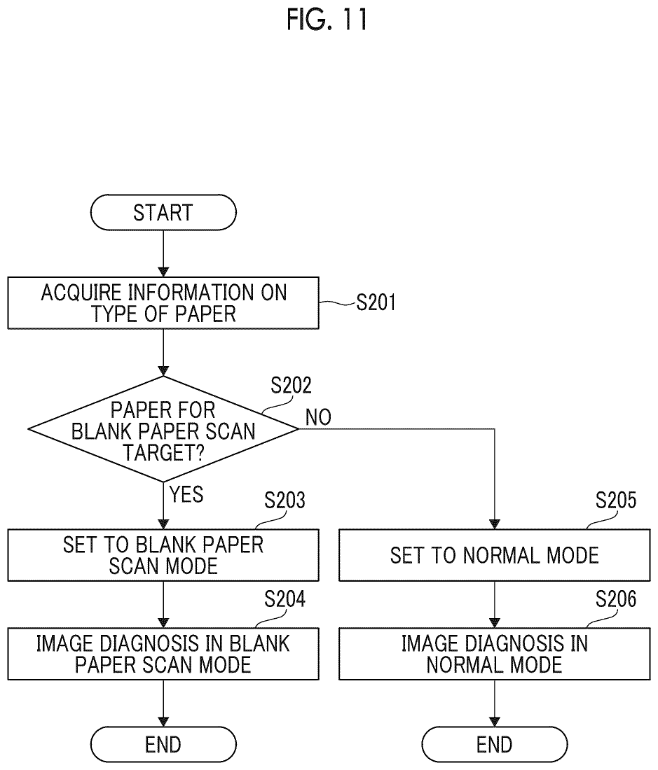

FIG. 11 is a flowchart illustrating an example of a process in a case of switching the process described above by a mode, based on information on a type of paper P. First, the server apparatus 200 (see FIG. 1) acquires the information on the type of paper P, from the image forming apparatus 100 via the communication line 190 (see FIG. 1) (step S201). The information on the type of paper P is, for example, information input from a user via the operation reception unit 132 (see FIG. 3) of the image forming apparatus 100 (see FIG. 1). For example, from the information on the type of acquired paper P, the CPU 11a of the server apparatus 200 determines whether or not the paper P is appropriate paper for performing a scanning process (hereinafter, abbreviated to “blank paper scanning”) on the paper P before an image is formed in a case where image diagnosis is performed (step S202). For example, it is determined whether or not the paper P is a type of paper or the like, such as recycled paper that is likely to cause faults.

In step S202, in a case of paper for blank paper scan target (YES in step S202), the server apparatus 200 sets an image diagnosis process to be performed in a blank paper scan mode (step S203), and transmits information indicating that the image diagnosis is to be performed in the blank paper scan mode to the image forming apparatus 100 via the communication line 190. In the image forming apparatus 100, the information indicating that the image diagnosis is to be performed in the blank paper scan mode is displayed on the operation reception unit 132 to guide a user. The image diagnosis process in the blank paper scan mode is executed (step S204), and the image diagnosis process is ended. The blank paper scan mode is a mode in which blank paper scanning is performed and image diagnosis is performed based on a blank paper image and a chart image.

In step S202, in a case where the paper is not paper for blank paper scan target (NO in step S202), the server apparatus 200 sets the image diagnosis process to be performed in a normal mode (step S205), and transmits information indicating the setting of the normal mode to the image forming apparatus 100 via the communication line 190. In the image forming apparatus 100, the information indicating that the image diagnosis is to be performed in the normal mode is displayed on the operation reception unit 132 to guide the user. The image diagnosis process in the normal mode is executed (step S206), and the image diagnosis process is ended. The normal mode is a mode in which image diagnosis is performed based on the chart image without performing the blank paper scan.

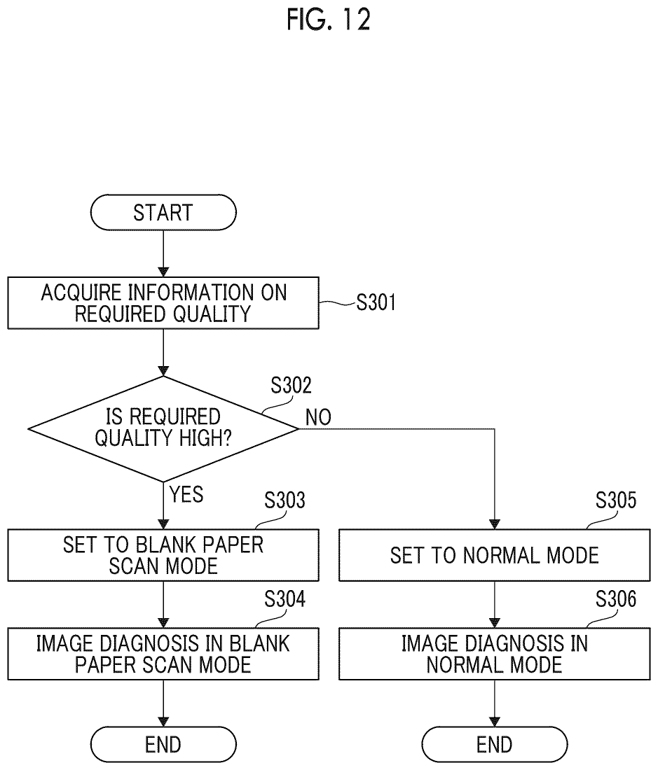

FIG. 12 is a flowchart illustrating an example of a process in a case of switching the process described above according to a mode, based on information on a required quality. First, the server apparatus 200 (see FIG. 1) acquires the information on the requested quality from the image forming apparatus 100 via the communication line 190 (see FIG. 1) (step S301). The information on the required quality is, for example, information input from a user via the operation reception unit 132 (see FIG. 3) of the image forming apparatus 100 (see FIG. 1). The CPU 11a of the server apparatus 200 determines whether or not the request quality is high, from the acquired information on the request quality (step S302).

In step S302, in a case where the required quality is high (YES in step S302), the server apparatus 200 sets to perform an image diagnosis process in a blank paper scan mode (step S303), and transmits information indicating that image diagnosis is to be performed in the blank paper scan mode to the image forming apparatus 100 via the communication line 190. In the image forming apparatus 100, the information indicating that the image diagnosis is to be performed in the blank paper scan mode is displayed on the operation reception unit 132 (see FIG. 3) to guide the user. The image diagnosis process in the blank paper scan mode is executed (step S304), and the image diagnosis process is ended.

In step S302, in a case where the required quality is low (NO in step S302), the server apparatus 200 sets to perform the image diagnosis process in a normal mode (step S305), and transmits information indicating the setting of the normal mode to the image forming apparatus 100 via the communication line 190. In the image forming apparatus 100, the information indicating that the image diagnosis is to be performed in the normal mode is displayed on the operation reception unit 132 to guide the user. The image diagnosis process in the normal mode is executed (step S306), and the image diagnosis process is ended.

As described above in detail, in the present exemplary embodiment, image diagnosis is performed by classifying whether a fault is a fault due to the paper P, a fault due to the scanning, or a fault due to image formation, based on detection coordinates of a blank paper image and detection coordinates of a chart image.

In the present exemplary embodiment, scanning on the paper P before the diagnosis image 61 is formed and scanning on the diagnosis paper CP after the diagnosis image 61 is formed are performed by the identical image scanning unit 130. In addition, in a case where the diagnosis is performed on the plurality of sheets of paper P, each paper is also scanned by the identical image scanning unit 130. In a case of classifying the fault, it is assumed that, in the example described above, a scanning position by the image scanning unit 130 does not deviate and position alignment at the identical position is performed. Meanwhile, in reality, the position slightly deviates, in some cases. In this case, it is possible to handle the case by, for example, correcting the position by considering the slight deviation.

In addition, in the present exemplary embodiment, the image diagnosis process is described as an example of the process executed by the server apparatus 200, and each processing may be distributed and processed by a plurality of processors. For example, there is also a case where the image diagnosis process is executed by a plurality of processors of the server apparatus 200 and the image forming apparatus 100, or a case where a plurality of apparatuses execute the function of the server apparatus 200.

### Supplementary Note

(((1)))

An image diagnosis system configured to:

scan paper before an image for image diagnosis is formed by an image forming apparatus;

scan the paper after the image is formed by the image forming apparatus; and

perform the image diagnosis by classifying at least one of a fault due to the paper, a fault due to the scanning, or a fault due to the image formation from the other fault, based on a scan image of the paper before the image is formed and a scan image of the paper after the image is formed.

(((2)))

The image diagnosis system according to (((1))),

wherein the image diagnosis is performed by classifying the fault due to the paper or the fault due to the scanning from the fault due to the image formation, based on the scan image of the paper before the image is formed and the scan image of the paper after the image is formed.

(((3)))

The image diagnosis system according to (((1))) or (((2))),

wherein by performing diagnosis using a scan image of the paper obtained by changing a scanning direction of the paper, the image diagnosis is performed by further classifying the fault due to the paper and the fault due to the scanning.

(((4)))

The image diagnosis system according to (((3))),

wherein identification information for distinguishing the paper from other paper is added to the paper, and

the image diagnosis is performed by recognizing the scanning direction by using the identification information.

(((5)))

The image diagnosis system according to (((1))),

wherein a plurality of sheets of paper before the image is formed are scanned in order, and the plurality of sheets of paper after the image is formed are scanned in a state in which the order is recognizable, and

the image diagnosis is performed by classifying the fault due to the paper, the fault due to the scanning, and the fault due to the image formation.

(((6)))

The image diagnosis system according to (((5))),

wherein identification information for distinguishing one paper from other paper among the plurality of sheets of paper is added to the plurality of sheets of paper before the image is formed, and

the plurality of sheets of paper after the image is formed are scanned in a state in which the order is recognizable by using the identification information.

(((7)))

An image diagnosis system comprising:

an image forming unit that forms an image for image diagnosis on paper;

an image scanning unit that scans the paper before the image is formed by the image forming unit and the paper after the image is formed by the image forming unit; and

an image diagnosis unit that performs the image diagnosis by classifying a fault due to the paper, based on a scan image of the paper before the image is formed and a scan image of the paper after the image is formed, which are scanned by the image scanning unit.

(((8)))

An image diagnosis system comprising:

one or a plurality of processors configured to:
acquire a first scan image obtained by scanning paper before an image is formed by an image forming apparatus;
acquire a second scan image obtained by scanning the paper after the image is formed by the image forming apparatus; and
perform image diagnosis by classifying a fault due to the paper, based on the first scan image and the second scan image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image diagnosis system configured to:
scan paper before an image for image diagnosis is formed by an image forming apparatus;
scan the paper after the image is formed by the image forming apparatus; and
perform the image diagnosis by classifying at least one of a fault due to the paper, a fault due to the scanning, or a fault due to the image formation from the other fault, based on a scan image of the paper before the image is formed and a scan image of the paper after the image is formed.

2. The image diagnosis system according to according to claim 1,
wherein the image diagnosis is performed by classifying the fault due to the paper or the fault due to the scanning from the fault due to the image formation, based on the scan image of the paper before the image is formed and the scan image of the paper after the image is formed.

3. The image diagnosis system according to claim 2,
wherein by performing diagnosis using a scan image of the paper obtained by changing a scanning direction of the paper, the image diagnosis is performed by further classifying the fault due to the paper and the fault due to the scanning.

4. The image diagnosis system according to claim 3,
wherein identification information for distinguishing the paper from other paper is added to the paper, and
the image diagnosis is performed by recognizing the scanning direction by using the identification information.

5. The image diagnosis system according to claim 1,
wherein a plurality of sheets of paper before the image is formed are scanned in order, and the plurality of sheets of paper after the image is formed are scanned in a state in which the order is recognizable, and
the image diagnosis is performed by classifying the fault due to the paper, the fault due to the scanning, and the fault due to the image formation.

6. The image diagnosis system according to claim 5,
wherein identification information for distinguishing one paper from other paper among the plurality of sheets of paper is added to the plurality of sheets of paper before the image is formed, and
the plurality of sheets of paper after the image is formed are scanned in a state in which the order is recognizable by using the identification information.

7. An image diagnosis system comprising:
an image forming unit that forms an image for image diagnosis on paper;
an image scanning unit that scans the paper before the image is formed by the image forming unit and the paper after the image is formed by the image forming unit; and
an image diagnosis unit that performs the image diagnosis by classifying a fault due to the paper, based on a scan image of the paper before the image is formed and a scan image of the paper after the image is formed, which are scanned by the image scanning unit.

8. An image diagnosis system comprising:
one or a plurality of processors configured to:
acquire a first scan image obtained by scanning paper before an image is formed by an image forming apparatus;
acquire a second scan image obtained by scanning the paper after the image is formed by the image forming apparatus; and
perform image diagnosis by classifying a fault due to the paper, based on the first scan image and the second scan image.
